(19) United States
(12) Patent Application Publication
(10) Pub. No.: US 2018/0061590 A1
(43) Pub. Date: Mar. 1, 2018

(54) SPACING DEVICE FOR MOUNTING AN ELECTRICAL SWITCH OR OUTLET COVER PLATE TO A MOUNTING SURFACE

(71) Applicant: Questech Corporation, Rutland, VT (US)

(72) Inventor: Roger Questel, Arlington, VT (US)

(73) Assignee: Questech Corporation, Rutland, VT (US)

(21) Appl. No.: 15/688,097

(22) Filed: Aug. 28, 2017

Related U.S. Application Data
(60) Provisional application No. 62/381,804, filed on Aug. 31, 2016.

(51) Int. Cl. H01H 9/02; H01R 13/46

(52) U.S. Cl. CPC H01H 9/02; H01R 2103/00; H01R 13/46

(57) ABSTRACT

The present invention is directed towards a spacer or spacing device designed to hold an electrical switch or outlet cover plate a desired distance from a mounting surface such as a wall.

### BACKGROUND OF THE INVENTION

With respect to electrical switch and outlet cover plates, standoff has been achieved through injection molding with plastic, creating a recess on the back of the cover plate. For wood and natural stone electrical switch and outlet cover plates, routing of the initially planner back surface has been practiced to create a recess on the back of the cover plate.

What is needed are new materials and methods of mounting electrical switch and outlet cover plates to a mounting surface where a standoff or space is required.

### SUMMARY OF THE INVENTION

The present invention relates to spacing devices or spacers used to create a space or standoff between a mounting surface and electrical switch and outlet cover plates. The present invention also relates to methods of use and kits to provide a standoff between the mounting surface and an electrical switch or outlet cover plate to be mounted while enabling ease of installation.

The spacing device of the present invention is designed to position electrical switch and outlet cover plates. The prior at is replete with electrical outlet cover plates. Electrical outlets (sockets or switches) are mounted in, usually, a wall, floor or ceiling. The box where the wiring meets the socket or switch is called an electrical box. The wires are connected to the socket or switch in the electrical box. The design of the box and socket or switch, as well as variations in how an electrician may mount the items, usually, if not always, results in screws or other parts extending beyond the mounting surface (e.g., beyond the flat surface of a wall). This creates the need for a recess behind the cover plate without which the cover plate would not lie flush with the mounting surface. In this regard, the spacing device or spacer of the present invention is sandwiched between the mounting surface and the electrical switch and outlet cover plate and is not attached to the mounting surface (i.e., a wall or other surface).

### BRIEF DESCRIPTION OF THE FIGURES

The figures present non-limiting embodiments of the present invention. One of ordinary skill in the art will understand that other embodiments may be encompassed by the present invention based in view of the teachings of this specification.

FIG. 1 shows a perspective view of a spacer of the present invention with an electrical switch plate cover (in dashed lines) positioned (fitted) on it.

FIG. 2 shows a perspective view of a spacer of the present invention without an electrical switch plate cover positioned on it.

FIG. 3 shows the top view of a spacer of the present invention.

FIG. 4 shows a left hand view of a spacer of the present invention.

FIG. 5 shows a front view of a spacer of the present invention.

FIG. 6 shows a right hand view of a spacer of the present invention.

FIG. 7 shows a bottom view of a spacer of the present invention.

FIG. 8 shows a back view of a spacer of the present invention.

### DETAILED DESCRIPTION OF THE INVENTION

The present invention is directed towards a device for creating spacing out or space between a surface and an electrical switch and outlet cover plate, as well as methods of use of the device when mounting the electrical switch and outlet cover plate to a mounting surface. That is, the present invention is directed towards a “spacing device” or “spacer,” the terms used synonymously herein. The spacing device of the present invention is shaped and used to hold the electrical cover outlet plate a specified distance from the electrical box on to which the electrical outlet cover plate is attached. An electrical outlet cover plate may be a cover plate for electrical sockets, electrical switches or a combination electrical socket and switch cover. The spacing device of the present invention may be used to create a space out from a mounting surface such as a wall or other surface.

In this regard, the spacing device of the present invention is a rectangular electrical switch or electrical outlet cover plate spacer for flush mounting to a wall to create spacing out from the wall. Although the shape of the spacing device of the present invention is typically rectangular, the spacing device can be any shape including, but not limited to, square, oval, round, triangular or any non-geometric shape. The electrical switch and outlet cover plate that will be used with the spacing device of the present invention will have a back surface, a front surface and edges. With regard to spacers for electrical switch or outlet cover plates, the spacer may be sized for single, double, triple or larger electrical outlet cover plates as well as for non-traditional shapes and sizes. The spacing device of the present invention may be sold or packaged with the electrical switch or outlet cover plate requiring a standoff or may be sold or packaged separately.

The electrical switch or outlet cover plate may be made from any suitable material. In one embodiment, the material is a moldable plastic or moldable thermoplastic (also known as “thermal plastic”). One or more thermoplastics may be used. When made of plastic or thermoplastic, the electrical outlet cover plate may be injection molded or may be made by open mold casting or liquid mold casting (i.e., pouring or flowing the liquid plastic into a molding tray and permitting it to harden). When this technique is used, the finished electrical switch or outlet cover plate will have a meniscus at the edges of the electrical switch or outlet cover plate where the plastic meets the mold and, likely, other imperfections on the back side of the electrical switch or outlet cover plate resulting from the molding process. These imperfections will not be visible when the electrical switch or outlet cover plate is mounted using the spacer of the present invention.

Any suitable polymer may be used to make the electrical switch or outlet cover plate to be mounted. Exemplary polymers known in the art include, but are not limited to, polyester, polyethylene terephthalate (PET), high-density polyethylene (HDPE), polyvinylidene cholate (PVDC), polyvinyl chloride (PVC), low density polyethylene (LDPE), polypropylene (PP), polystyrene (PS), high impact polystyrene (HIPS), polyamides (PA), polycarbonate (PC), acrylonitrile butadiene styrene (ABS), polycarbonate/acrylonitrile butadiene styrene (PC/ABS) and polyurethanes (PU).

The electrical switch or outlet cover plate may also be made of wood, stone, metal or any other suitable material. Wood may be laser cut or cut with saws. Stone may be cut and, if necessary, ground into shape. Metal may be molded or cut into shape. When these materials are used a molding meniscus will not be present. For whatever material the spacing device of the present invention is made, the techniques necessary to make the spacing device of the present invention are known to those of ordinary skill in the applicable art. Whatever material is used, it may be shaped or decorated as desired.

The spacing device of the present invention will have an outer perimeter and an inner perimeter. Depending on the use of the spacing device, the outer perimeter and inner perimeter may be of the same substantial shape. In other words, if the outer perimeter is rectangular or substantially rectangular, the inner perimeter is rectangular or substantially rectangular. With regard to shapes, the term “substantially” as in “substantially rectangular” shall mean that the shape may have minor deviations from a geometrically perfect shape. Further, shapes that traditionally have corners, such as rectangles, squares, and other geometric shapes, may have rounded corners and still be referred to by the geometric term as applied to the shape without rounded corners.

The shapes of the outer and inner perimeters need not to match. For example, the inner perimeter may be rectangular to fit around an electrical box but the outer perimeter may be of another shape, such as oval.

The spacing device of the present invention will have a contact surface which, in use, contacts or substantially contacts the back of the electrical switch or outlet cover plate to be spaced out from the wall or other surface. The term “substantially contacts” shall mean that at least 50%, 75%, 85%, 90%, 95% or 99% or more of the contact surface of the spacing device contacts the back of the electrical switch or outlet cover plate to be spaced out. In this regard, the back of the electrical switch or outlet cover plate is substantially flat or planner. The contact surface of the spacing device or spacer creates a standoff distance or space out for the electrical switch or outlet cover plate. The standoff distance may be any desired distance. When used for an electrical outlet cover plate the standoff distance is from about 2.0 mm to 5.0 mm. In a preferred embodiment, the standoff distance is about 3.0 to 3.5 mm or about 3.2 mm or about ⅛ inch.

The spacing device of the present invention will have a framing edge which, when in use, substantially contacts the edge of the electrical switch or outlet cover plate. The term “substantially contacts” shall mean that at least 50%, 75%, 85%, 90%, 95% or 99% or more of the framing edge of the spacing device contacts the edge of the electrical switch or outlet cover plate to be spaced out. In this regard, the edge of the electrical switch or outlet cover plate substantially mirrors the shape of the framing edge of the spacing device. When used with an electrical outlet cover plate the framing edge is from about 0.5 mm to about 5.0 mm above the contact surface.

In some embodiments, the spacing device of the present invention will have a recessed channel between the contact surface and the framing edge, the recessed channel being from about 0.5 mm to 2.0 mm below the contact surface. In one aspect, the recessed channel creates an area for the meniscus or other imperfections on the edge of the electrical switch or outlet cover plate, if present, to insert into such that the back of the electrical switch or outlet cover plate can substantially contact the contact surface of the spacing device of the present invention. In another embodiment, the spacing device of the present invention does not have a recess between the framing edge and contact surface.

The spacing device of the present invention may or may not be recessed into the mounting surface. In a preferred embodiment, the spacing device has a back surface that, when in use, is flush or substantially flush with the mounting surface. The back surface of the spacing device is, in a preferred embodiment, flat or substantially flat. In the context of the present invention, the term “substantially flat,” when applied to the back of the spacing device of the present invention, includes any surface molding variations (such a flow indices that result from the molding process) and any meniscuses or other manufacturing imperfections. The term “planner,” as used herein, is synonymous with the term “flat.”

The present invention is also directed towards the spacer of the present invention in combination with an electrical switch or outlet cover plate having a substantially flat or planner back.

The present invention also relates to methods of use of the spacing device of the present invention. An exemplary method of mounting an electrical switch or outlet cover plate, with the spacing device of the present invention comprises providing the spacing device or spacer of the present invention, positioning the electrical switch or outlet cover plate on the spacer such that the edges of the electrical switch or outlet cover plate substantially contact the framing edge of the spacer and the back surface of the electrical switch or outlet cover plate substantially contacts the contact surface of the spacer to create an electrical switch or outlet cover plate fitted to the spacing device (i.e., a fitted electrical switch or outlet cover plate), and then mounting the fitted electrical switch or outlet cover plate to an electrical box on a wall or other surface. Any mounting method known in the applicable art may be employed and may include any variety of one or more of screws, glue, rivets, nails, push pins, bolts, etc.

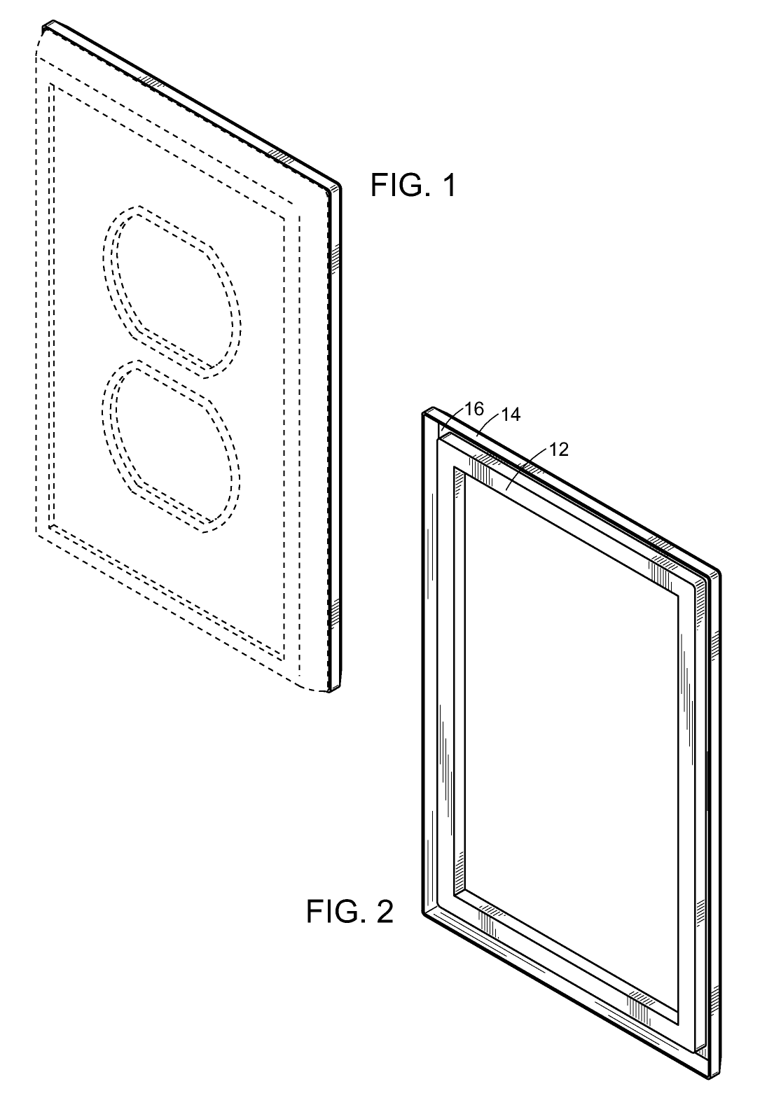

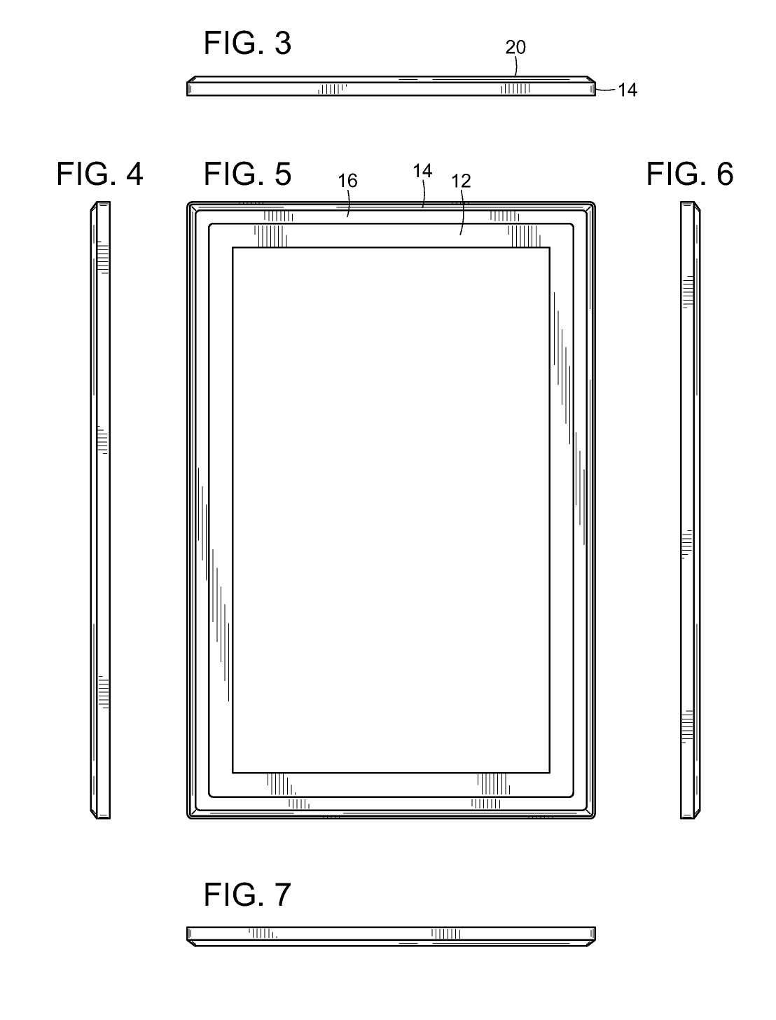

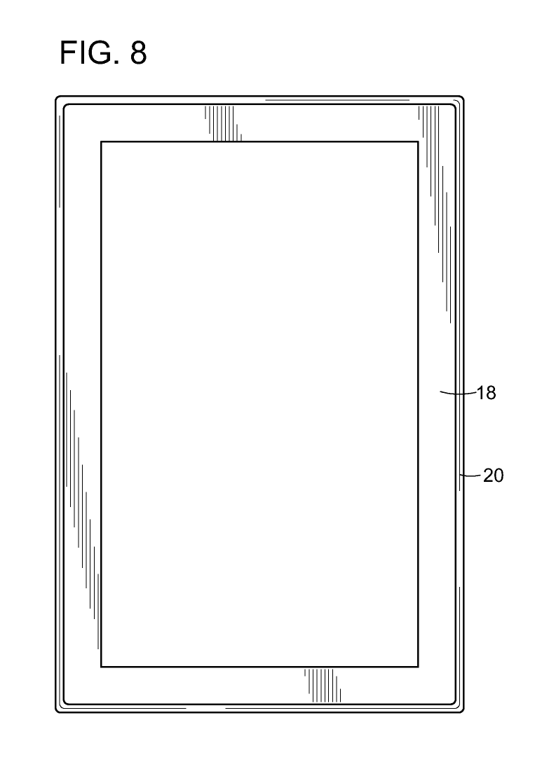

Looking now at the figures, FIG. 1 shows an electrical switch plate cover (in dashed lines) fitted to a spacer of the present invention. FIG. 2 shows a perspective view of an embodiment of a spacer of the present invention. Shown are the contact surface 12, the framing edge 14 and the recess 16 between the contact surface and framing edge.

FIG. 5 is another view of a spacer of the present invention. Shown are the contact surface 12, the framing edge 14 and the recess 16 between the contact surface and framing edge. FIG. 8 shows the back surface 18 of a spacer of the present invention. In an embodiment, the back surface 20 of the framing edge may be angled, squared or curved (i.e., contoured).

In the present invention, the transitional phrase “consisting essentially of” limits the scope of a claim to the specified materials or steps “and those that do not materially affect the basic and novel characteristic(s)” of the claimed invention. It is not intended to be synonymous with “comprising.”

Further, the present invention is directed toward kits comprising one or more spacer(s), electrical switch or outlet cover plate(s), screws or other attachment devices, and instructions or directions for use.

The terms “about” and “approximately” include the recited number and ±20%, ±10% or ±5%.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

1. A rectangular electrical switch or electrical outlet cover plate spacer for flush mounting to a wall to create spacing out from the wall, an electrical switch or electrical outlet cover plate having a back surface and edges, the electrical cover plate spacer comprising:
a. a substantially rectangular outer perimeter and a substantially rectangular inner perimeter,
b. a contact surface which, in use, substantially contacts the back surface of the electrical switch or outlet cover plate, thereby providing a standoff distance between the wall and the back surface of the electrical cover plate, the standoff distance being from 2.5 mm to 5.0 mm;
c. a framing edge which, when in use, substantially contacts the edges of the electrical switch or outlet cover plate, the framing edge being 0.5 to 5 mm above the contact surface;
d. a recessed channel between the contact surface and the framing lip, said recessed channel being 0.5 mm to 2 mm below the contact surface.

2. The electrical switch or electrical outlet cover plate spacer of claim 1, comprising one or more thermoplastics.

3. The electrical switch or electrical outlet cover plate spacer of claim 2, wherein said thermoplastic is selected from the group consisting of rigid, semi-rigid and flexible thermoplastics.

4. The electrical switch or electrical outlet cover plate spacer of claim 1, wherein said standoff is about 3.0 mm to about 3.5 mm.

5. The electrical switch or electrical outlet cover plate spacer of claim 1, wherein said standoff is about ⅛ inch.

6. A method for mounting an electrical switch or electrical outlet cover plate over an electrical box, comprising:
a. providing: i) the electrical switch or outlet cover plate spacer of claim 1 and, ii) an electrical switch or outlet cover plate having a back surface and edges;
b. positioning the electrical switch or electrical outlet cover plate on the electrical switch or electrical outlet cover plate spacer such that the electrical switch or electrical outlet cover plate edges substantially contact the framing edge of the electrical switch or electrical outlet cover plate spacer and the back surface of the electrical switch or electrical outlet cover plate substantially contacts the contact surface of the electrical switch or electrical outlet cover plate spacer to create a fitted electrical switch or electrical outlet cover plate;
c. mounting the fitted electrical switch or electrical outlet cover plate over the electrical box.

7. The method of claim 6, comprising the use of one or more screws to mount said fitted electrical switch or electrical outlet cover plate over the electrical box.

8. A rectangular electrical switch or electrical outlet cover plate spacer for flush mounting to a wall to create spacing out from the wall, an electrical switch or electrical outlet cover plate having a back surface and edges, the electrical switch or electrical outlet cover plate spacer comprising:
a. a substantially rectangular outer perimeter and a substantially rectangular inner perimeter,
b. a contact surface which, in use, substantially contacts the back surface of the electrical switch or outlet cover plate, thereby providing a standoff distance between the wall and the back surface of the electrical switch or electrical outlet cover plate, the standoff distance being from 2.5 mm to 5.0 mm;
c. a framing edge which, when in use, substantially contacts the edges of the electrical switch or outlet cover plate, the framing edge being 0.5 to 5 mm above the contact surface.

9. The electrical switch or electrical outlet cover plate cover spacer of claim 8, comprising one or more thermoplastics.

10. The electrical switch or electrical outlet cover plate spacer of claim 9, wherein said thermoplastic is selected from the group consisting of rigid, semi-rigid and flexible thermoplastics.

11. The electrical switch or electrical outlet cover plate spacer of claim 8, wherein said standoff is about 3.0 mm to about 3.5 mm.

12. The electrical switch or electrical outlet cover plate spacer of claim 8, wherein said standoff is about ⅛ inch.

13. A kit comprising the electrical switch or outlet cover plate spacer of claim 1, an electrical switch or outlet cover plate and instructions for use.

14. The kit of claim 14, further comprising one or more attachment screws.
